(19) United States
(12) Patent Application Publication
(10) Pub. No.: US 2005/0109412 A1
(43) Pub. Date: May 26, 2005

(54) Retaining device for a tube plug

(76) Inventor: Glenn F. Jorgensen, Ridgewood, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/720,864

(22) Filed: Nov. 24, 2003

(51) Int. Cl. F16L 55/10

(52) U.S. Cl. 138/89

(57) ABSTRACT

A retaining device for a tube plug made of an elastomeric material and having a generally hollow body elongated along an axis, with a closed front end and an open rear end leading to a central axially extending blind hole having a predetermined diameter is provided which is a generally cylindrical non-expandable insert member having a diameter slightly greater than the blind hole diameter and an enlarged head portion, wherein, upon insertion of the insert member into the central blind hole of the tube plug, the tube plug body will be diametrically enlarged.

### BACKGROUND OF THE INVENTION

The present invention relates to improvements for a plug used to form a seal for tubes, pipes and similar conduits which transport steam, liquid or gases under pressure and a method for retaining such a plug in place.

Tube plugs are used to seal the open ends of tube, such as tubes in a heat exchanger. Various configurations of tube plugs are known, such as those described in U.S. Pat. Nos. 4,170,247; 4,390,042; 4,502,511; 4,751,944 and 5,311,91. Several of these constructions are fairly complex in that they require components to be molded in place in or on the plug, require a specially configured, and a varying diameter of an, internal blind hole, thereby increasing the cost and complexity of the plug, as well as any retaining device used to hold the plug in place within a tube.

One type of tube plug currently being sold by JNT Technical Services, Inc., the assignee of the present application, is shown in FIGS. 1-3 and includes a tube plug 20 made of an elastomeric material and having a generally hollow body 22 elongated along an axis 24, with a rounded front end 26 and an open rear end 28 leading to a central axially extending blind hole 30 having a predetermined internal diameter 32. Generally the internal diameter 32 is constant along the length of the blind hole 30. In use, a tube plug 20 having an external diameter 34 slightly greater than an internal diameter 36 of a tube 38 is inserted into the tube and a tool 40 having an elongated rod-like extension 42 is inserted into the blind hole 30. As the tool 40 is pushed, the plug 20 is caused to elongate, thereby reducing its outer diameter, and allowing the plug to slide into the tube. The plug is pushed into the tube until a flange 44 formed on the plug 20 adjacent to the open rear end 28 abuts against an open end of the tube.

When the tool 40 is removed from the plug 20, the elongation force is removed, and the plug moves to resume its original external diameter 34, which was greater than the internal diameter 36 of the tube, thereby effecting a tight seal of the plug against the wall of the tube. In some situations, the retention by the plug itself is sufficient to hold the plug in place. However, if the plug itself develops a leak, the contents of the tube will find an unobstructed path through the once blind hole to the exterior, which defeats the purpose of the plug.

In other situations, where the interior of the tube is placed under high pressure, additional retaining devices are used to hold the plug in place within the tube as described in the aforementioned patents. Such additional retaining devices generally involve a threaded arrangement and rotation of at least a portion of the retaining device relative to the tube plug to effect the retention. Such arrangements therefore require careful machining and aligning of parts, which increase the cost and complexity of the components, and which increase the cost, and complexity, and time required for assembly of the retaining member and the plug.

It would therefore be an improvement in this art if a retaining device were provided for a tube plug for securely engaging with the tube plug without the need for complex configurations of the tube plug or complex or time consuming manipulations of the retaining device relative to the tube plug during assembly.

### SUMMARY OF THE INVENTION

A retaining device is provided for a tube plug of the above described configuration comprising a generally cylindrical non-expandable insert member having a diameter slightly greater than the blind hole, wherein, upon insertion of the insert member into the central blind hole of the tube plug, the tube plug body will be diametrically enlarged.

The insert member may have an outer surface provided with a plurality of annular ribs and the ribs may comprise reverse taper serrations. The insert member may be provided with an enlarged head portion, and the enlarged head portion may include a surface configuration arranged to accept a removal tool, such as a hole extending perpendicular to an axis of the insert member.

A method for securing a tube plug in a tube is also provided, comprising the steps of selecting a tube plug having an outer diameter slightly greater than an internal diameter of said tube, the tube plug being made of an elastomeric material and having a generally hollow body elongated along an axis, with a rounded closed front end and an open rear end leading to a central axially extending blind hole having a predetermined diameter, inserting a tool into the open end of the tube plug and placing the rounded end of the tube plug into an open end of the tube, pushing the tool in the direction of the tube to elongate the tube plug, thereby decreasing its diameter to allow the tube plug to slide into the tube, and continuing the pushing until the tube plug is substantially fully inserted into the tube, selecting a static insert member having a diameter slightly greater than the internal diameter of the blind hole, and driving the insert member into the blind hole.

The method may also include driving the insert member into the blind hole with a tool, such as a mallet. When the tube plug includes a flange arranged adjacent to the open rear end, the method may include pushing the tool until the tube plug flange abuts against the open end of the tube. When the insert member includes an enlarged head at one end, the method may include driving the insert member into the blind hole until the head engages the tube plug.

The method may also include the further step of removing the insert member from the tube plug by engaging a tool with the head and axially withdrawing the insert member from the tube plug.

The invention also is directed to a tube plug assembly comprising a tube plug made of an elastomeric material and having a generally hollow body elongated along an axis, with a rounded front end and an open rear end leading to a central axially extending blind hole having a predetermined internal diameter, and a non-expandable insert member having a diameter slightly greater than the blind hole diameter, wherein, upon insertion of the insert member into the central blind hole of the tube plug, and without further manipulation of the insert, the tube plug body will be diametrically enlarged.

The tube plug assembly may include annular ribs on an outer surface of the insert member, and the ribs may comprise reverse taper serrations. The insert member may have an enlarged head portion which prevents the insert member from being over inserted into the central blind hole. The enlarged head portion may includes a surface configuration arranged to accept a removal tool, such as a hole extending perpendicular to an axis of the insert member formed in the enlarged head portion.

In an embodiment of the invention, the insert member may be provided in a color contrasting to a color of the tube plug. Also, the insert member may have an outer surface which engages an inner surface of the blind hole in a liquid tight manner. The blind hole of the tube plug may have a constant diameter extending substantially along its entire length, and, once fully inserted, the insert may enlarge the diameter of the tube plug body along a full length of the insert.

### BRIEF DESCRIPTION OF THE DRAWINGS

Various other objects, features and attendant advantages of the present invention will be more fully appreciated as the same becomes better understood from the following detailed description when considered in connection with the accompanying drawings in which like reference characters designate like or corresponding parts throughout the several views and wherein:

FIG. 1 is a side sectional view of a prior art tube plug.

FIG. 2 is a side sectional view the tube plug of FIG. 1 being inserted into a tube with a tool, as is known in the prior art.

FIG. 3 is a sectional view of the tube with the tube plug fully inserted and shown in elevation, as is known in the prior art.

FIG. 4 is a side elevational view of a retaining insert for the tube plug, embodying the principles of the present invention.

FIG. 5 is a side view, partly in section, showing the insert about to be inserted into the tube plug.

FIG. 6 is side view, partly in section, showing the insert fully inserted into the tube plug.

FIG. 7 is a view similar to FIG. 5, showing the use of a tool to drive the insert into the tube plug.

FIG. 8 is a view similar to FIG. 6, showing the use of a tool to remove the insert from the tube plug.

### DETAILED DESCRIPTION OF THE PREFERRED EMBODIMENTS

The present invention relates to a retaining device for a tube plug, a method for securing a tube plug, and a tube plug assembly.

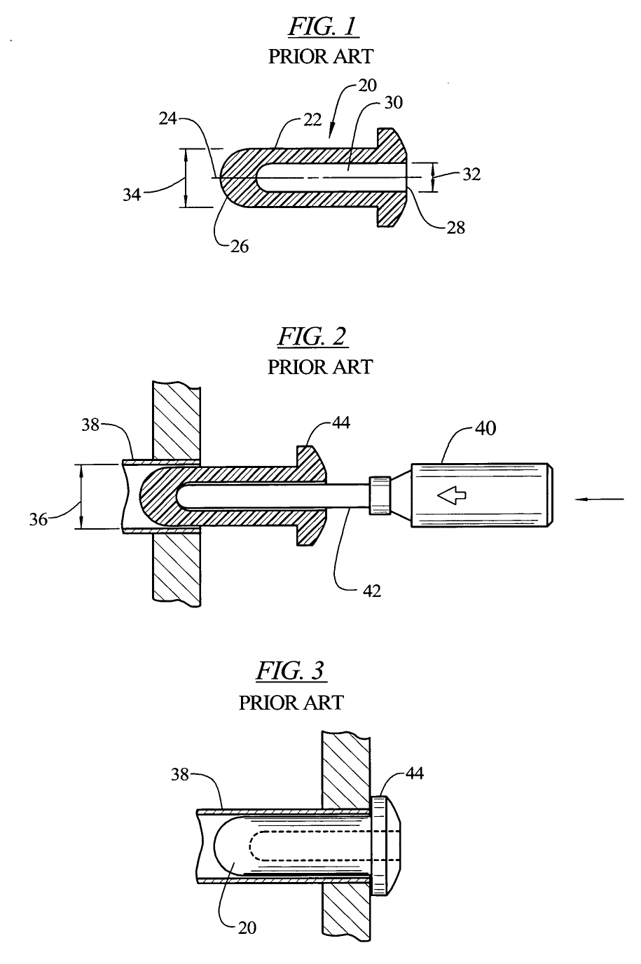

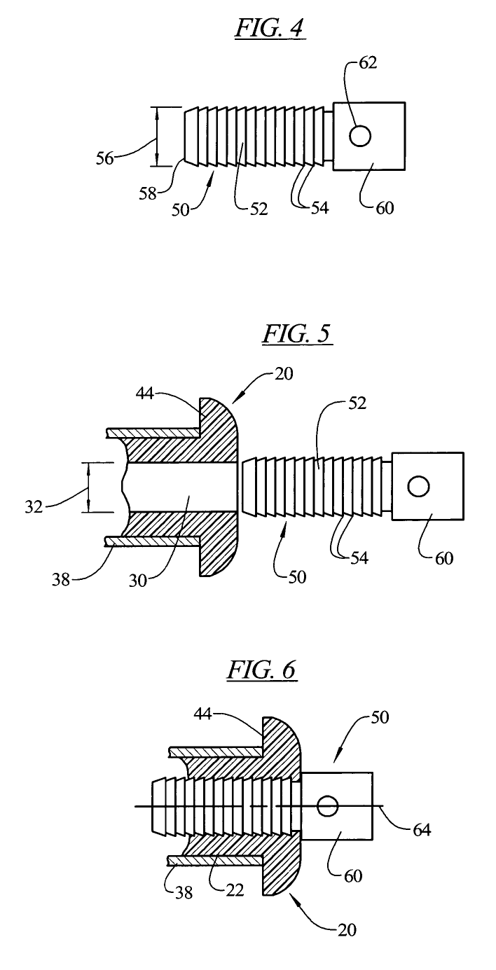

A tube plug, such as the tube plug 20 described above, and shown in FIGS. 1-3 may be used with the present invention. Other configurations of tube plugs may also be utilized without departing from certain aspects of the present invention. For example, even though the tube plug 20 illustrated in FIG. 1 has a flange 44, such a construction is not required for all aspects of the present invention. Also, The blind hole 30 is shown as having a constant diameter throughout its length, however, this is not necessary for all aspects of the present invention, even though certain advantages accrue with the use of a constant diameter blind hole, including ease of manufacture and assembly. The outer diameter 34 of the tube plug 20 is shown as being constant throughout the length of the tube plug, but this is not necessary for all aspects of the present invention and could be tapered or ribbed as known in the art. The closed end 26 of the tube plug is shown as being rounded, in the sense of a curve that is an arc of a circle. Such an exact roundness is not required, and the term rounded as used herein, is meant to encompass shapes other than that specifically shown, where a tip of the end is smaller in radial extent than a largest diameter of the body of the tube plug, such that the tip is more easily inserted into the open end of the tube. Thus, a chamfered or a conical shape, or a stepped reduced diameter shape would be included in the term rounded.

The present invention comprises an insert member 50 as shown in FIG. 5. The insert member 50 has a body portion 52 that is generally cylindrically shaped. In certain embodiments of the invention, the insert member 50 is non-expandable, meaning that it retains its shape and cannot be made to change that shape under normal intended use, such as by increasing its external diameter via some manipulation. In this sense, the insert member 50 may be a unitary and static member in that it does not include moving parts and all of its parts remain stationary relative to one another. While the insert member 50 illustrated may be formed of a single material and from a single part, the invention also contemplates insert members being formed of multiple pieces or from parts of different material, yet once joined into a single, unitary member, remaining fixed relative to one another. As an example, the insert member may be a molded plastic material, with a different plastic, metal or other material being insert molded into the member. The insert member 50 may also be formed of a plurality of pieces that are originally separately formed, yet joined together and held against further relative movement, such as by friction fits, locking detents, adhesives or other fastening devices or arrangements.

The body portion 52 of the insert member 50 may have a smooth outer surface, or may be provided with a non-smooth surface configuration, such as the configuration shown where a series of annular ribs 54 are formed on its outside. The ribs 54 may have a reverse taper, as shown, that is, the walls of the ribs may be angled to facilitate insertion of the insert member 50 into the tube plug 20, and to interfere with or impede removal of the insert member from the tube plug. Ribs of other configurations, such as rounded ribs, or rectangular cross section ribs may be used within the scope of the present invention. Also, a greater or lesser number of ribs than that shown may be utilized. The use of a plurality of ribs 54 provides the further advantage that a series of seals are provided by the ribs in the interior of the tube plug 20 between the insert member 50 and the tube plug.

In use, an insert member 50 having an external diameter 56 slightly greater than the diameter 56 of the blind hole 30, is selected. Wherein, upon insertion of the insert member 50 into the central blind hole 30 of the tube plug 20, as shown in FIGS. 5 and 6, the tube plug body 22 will be diametrically enlarged, and hence pressed into greater contact with the tube 38 to enhance the seal between the tube plug and the tube, and to increase the force required to dislodge the tube plug from the tube. Preferably, a tip 58 of the insert member 50 has a reduced diameter, or is otherwise rounded as previously defined, to facilitate insertion of the insert member into the tube plug 20. Also, the outer surface of the insert member 50 will be in a liquid tight engagement with the blind hole 30 of the tube plug 20. In this manner, if the body 22 of the tube plug 20 develops a leak along its length, from an outside of the tube plug to the blind hole 30, the insert member 50 will provide a seal to stop the leak and preserve the liquid tight integrity of the tube plug.

The outer diameter 56 of the insert member 50 may be constant along the length of the insert member, or it may vary, such as by providing a gradually increasing diameter along the length to facilitate insertion. Further, the diameter may vary along the length to correspond to a varied diameter of the blind hole 30. When the diameter 56 of the insert member 50 corresponds with the diameter 32 of the blind hole 30 (whether they are both constant or both similarly changing, and the insert member diameter being always slightly greater at corresponding locations), the insert member 50 will enlarge the diameter of the tube plug body 22 along a full length of the insert member.

The insert member 50 may be provided with an enlarged head portion 60. As shown in FIG. 6, when the insert member 50 is fully inserted into the tube plug 20, the enlarged head 60 will abut against the tube plug to prevent the insert member from being over inserted in to the tube plug. The enlarged head portion 60 may include a surface configuration 62 arranged to accept a removal tool (see FIG. 8 discussed below), such as a hole extending perpendicular to an axis 64 of the insert member.

A particular suitable material for the tube plug 20 is BUNA N rubber, although other elastomeric materials may be utilized which permit temporary deformation and are resilient to return to their original shape. A particular suitable material for the insert member 50 is a hard, rigid plastic material, such as______ . A metal material, such as brass, may also be utilized for the insert member 50. The insert member material should be able to retain its shape under the insertion pressures and the temperatures and other conditions of the inserted environment, such as the interior of the tube 38. When the tube plug 20 and the insert member 50 are to be used in difficult to see locations, it may be desirable to form the two parts from material that have different colors, particularly contrasting colors. For example, when using BUNA N rubber, in a black color, a white plastic material may be used for the insert member.

The present invention provides a method for securing the tube plug 20 in a tube 38 comprising the following steps. A tube plug 20 is selected having an outer diameter 34 slightly greater than an internal diameter 36 of the tube. The tube plug 20 is made of an elastomeric material and has a generally hollow body 22 elongated along an axis 24, with a rounded closed front end 26 and an open rear end 28 leading to a central axially extending blind hole 30 having a predetermined diameter 32. A tool 40 is inserted into the open end of the tube plug 20 and the rounded end 26 of the tube plug is placed into an open end of the tube 38. The tool is pushed in the direction of the tube 38 to elongate the tube plug, thereby decreasing its diameter 34 to allow the tube plug to slide into the tube 38 until the tube plug is substantially fully inserted into the tube. A static insert member 50 is selected having a diameter 56 slightly greater than the internal diameter 32 of the blind hole 30. The insert member 50 is then driven into the blind hole 30.

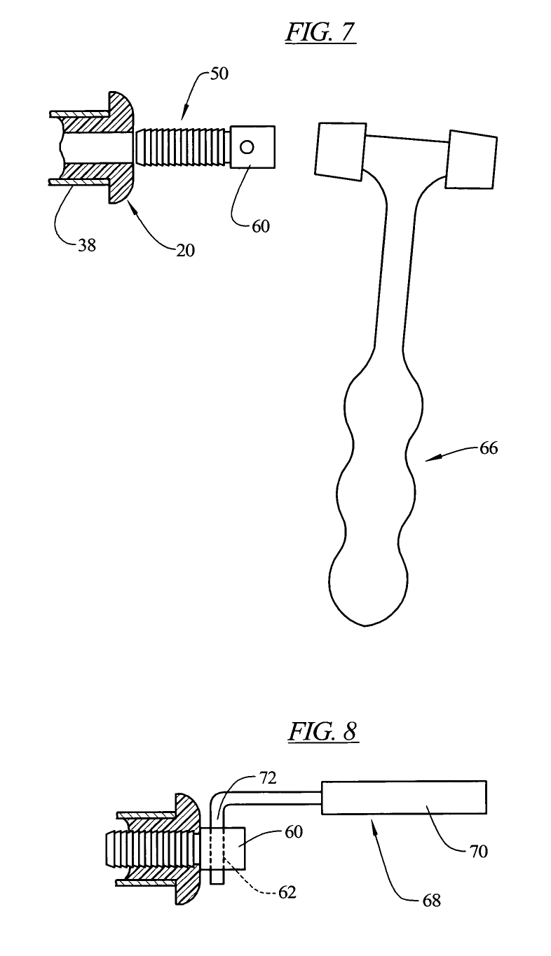

A tool 66 (FIG. 7), such as a mallet, may be used to drive the insert member 50 into the blind hole 30. The tube plug 20 may include a flange 44 arranged adjacent to the open rear end 28, in which case, the tool would be pushed until the tube plug flange abuts against the open end of the tube (FIG. 3). The insert member 50 may include an enlarged head 60 at one end. In this case, the step of driving the insert member 50 would include inserting the insert into the blind hole 30, at an end opposite the head 60, and moving the insert member into the blind hole until the head engages the tube plug (FIG. 6).

The method may also include the further step of removing the insert member 50 from the tube plug 20 by engaging a tool 68 (FIG. 8) with the surface configuration 62 of the head 60 and axially withdrawing the insert member from the tube plug. As shown in FIG. 8, the tool 66 may include a manually graspable handle portion 70 and a head engaging portion 72. When the surface configuration 62 is a hole extending perpendicular to the axis 64 of the insert member 50, the head engaging portion 72 may be a cylindrical element extending perpendicular to the handle 70. Once engaged, an axially directed force applied to the handle would be sufficient to disengage the insert 50 from the tube plug 20. Other surface configurations could be utilized on the head 60, including flanges, ears, projections or recesses that allow for a grasping of the head and the application of an axially directed force to remove the insert member.

As is apparent from the foregoing specification, the invention is susceptible of being embodied with various alterations and modifications which may differ particularly from those that have been described in the preceding specification and description. It should be understood that we wish to embody within the scope of the patent warranted hereon all such modifications as reasonably and properly come within the scope of our contribution to the art.

1. A tube plug assembly comprising:
a tube plug made of an elastomeric material and having a generally hollow body elongated along an axis, with a rounded front end and an open rear end leading to a central axially extending blind hole having a predetermined internal diameter; and
a non-expandable insert member having a diameter slightly greater than said blind hole diameter;
wherein, upon insertion of said insert member into said central blind hole of said tube plug, and without further manipulation of said insert, said tube plug body will be diametrically enlarged.

2. A tube plug assembly according to claim 1, wherein said insert member has an outer surface comprising annular ribs.

3. A tube plug assembly according to claim 2, wherein said ribs comprise reverse taper serrations.

4. A tube plug assembly according to claim 1, wherein said insert member has an enlarged head portion which prevents said insert member from being over inserted into said central blind hole.

5. A tube plug assembly according to claim 4, wherein said enlarged head portion includes a surface configuration arranged to accept a removal tool.

6. A tube plug assembly according to claim 5, wherein said surface configuration comprises a hole extending perpendicular to an axis of said insert member formed in said enlarged head portion.

7. A tube plug assembly according to claim 1, wherein said insert member is provided in a color contrasting to a color of said tube plug.

8. A tube plug assembly according to claim 1, wherein said insert member has an outer surface which engages an inner surface of said blind hole in a liquid tight manner.

9. A tube plug assembly according to claim 1, wherein said blind hole has a constant diameter extending substantially along its entire length.

10. A tube plug assembly according to claim 9, wherein said insert enlarges said diameter of said tube plug body along a full length of said insert.

11. A method for securing a tube plug in a tube comprising:
selecting a tube plug having an outer diameter slightly greater than an internal diameter of said tube, said tube plug being made of an elastomeric material and having a generally hollow body elongated along an axis, with a rounded closed front end and an open rear end leading to a central axially extending blind hole having a predetermined diameter;
inserting a tool into said open end of said tube plug and placing said rounded end of said tube plug into an open end of said tube;
pushing said tool in the direction of said tube to elongate said tube plug, thereby decreasing its diameter to allow said tube plug to slide into said tube, and continuing said pushing until said tube plug is substantially fully inserted into said tube;
selecting a static insert member having a diameter slightly greater than said internal diameter of said blind hole; and
driving said insert member into said blind hole.

12. A method according to claim 11, wherein said insert member is driven into said blind hole with a tool.

13. A method according to claim 11, wherein said insert member is driven into said blind hole with a mallet.

14. A method according to claim 11, wherein said tube plug includes a flange arranged adjacent to said open rear end and said tool is pushed until said tube plug flange abuts against said open end of said tube and said insert member includes an enlarged head at one end, and said step of driving said insert member includes inserting said insert into said blind hole, at an end opposite said head, and moving said insert member into said blind hole until said head engages said tube plug.

15. A method according to claim 14, including the further step of removing said insert member from said tube plug by engaging a tool with said head and axially withdrawing said insert member from said tube plug.

16. A retaining device for a tube plug made of an elastomeric material and having a generally hollow body elongated along an axis, with a closed front end and an open rear end leading to a central axially extending blind hole having a predetermined diameter; comprising:
a generally cylindrical non-expandable insert member having a diameter slightly greater than said blind hole diameter and an enlarged head portion; wherein, upon insertion of said insert member into said central blind hole of said tube plug, said tube plug body will be diametrically enlarged.

17. A retaining device according to claim 16, wherein said insert member has a outer surface provided with a plurality of annular ribs.

18. A retaining device according to claim 17, wherein said ribs comprise reverse taper serrations.

19. A retaining device according to claim 16, wherein said enlarged head portion includes a surface configuration arranged to accept a removal tool.

20. A retaining device according to claim 19, wherein said surface configuration comprises a hole extending perpendicular to an axis of said insert member.

21. A tube plug assembly comprising:
a tube plug made of an elastomeric material and having a generally hollow body elongated along an axis, with a rounded front end and an open rear end leading to a central axially extending blind hole having a predetermined internal constant diameter extending substantially along an entire length of said hole; and
a non-expandable insert member having a diameter extending substantially along its entire length which is slightly greater than said blind hole diameter, an outer surface comprising annular ribs and an enlarged head portion which prevents said insert member from being over inserted into said central blind hole; wherein, upon insertion of said insert member into said central blind hole of said tube plug, and without further manipulation of said insert, said tube plug body will be diametrically enlarged along substantially said full length of said insert.

22. A tube plug assembly according to claim 21, wherein said ribs comprise reverse taper serrations.

23. A tube plug assembly according to claim 21, wherein said enlarged head portion includes a surface configuration arranged to accept a removal tool.

24. A tube plug assembly according to claim 1, wherein said insert member is provided in a color contrasting to a color of said tube plug.
